(19) United States
(12) Patent Application Publication
(10) Pub. No.: US 2010/0182726 A1
(43) Pub. Date: Jul. 22, 2010

(54) INRUSH CURRENT LIMITATION CIRCUIT

(75) Inventors: ZHEN-HUA XIONG, Shenzhen City (CN); HUI-HUI HE, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 12/427,729

(22) Filed: Apr. 21, 2009

(30) Foreign Application Priority Data
Jan. 16, 2009 (CN) 200910300234.7

(51) Int. Cl. H02H 9/02

(52) U.S. Cl. 361/93.9

(57) ABSTRACT

An inrush current limitation circuit for limiting inrush current when powered-on includes a power source, a switch, a voltage dividing circuit, a second diode, a transistor, a zener diode, a charging capacitor and a first diode. The voltage dividing circuit is connected between a second end of switch and a ground to divide the direct current voltage to obtain a trigger voltage signal. An anode of the second diode is connected to the second end of the switch. A base of the transistor electrically is connected to a cathode of the second diode, and a collector connected to the cathode of the second diode. A cathode of the zener diode is connected to the base of the transistor; an anode of the zener diode is connected to the ground.

### BACKGROUND

1. Technical Field

Embodiments of the present disclosure relate to power source protection circuits, and particularly to an inrush current limitation circuit.

2. Description of Related Art

Inrush current may refer to the maximum, instantaneous current inflowing through a power source when the power source is turned on. For example, a relatively large difference between a band-gap voltage that is internally generated and a voltage of an output capacitor of a power source may exist in an initial transient state. As a result, a controller of the source may charge the output capacitor by a relatively large current. This relatively large current may be the result of an inrush current inflowing through the power source. The inrush current may have a negative influence upon the reliability of the power source and peripheral circuits.

That is, the peripheral circuits need one inrush current limitation circuit for reducing an inrush current inflowing through the power source during an initial transient state.

### BRIEF DESCRIPTION OF THE DRAWINGS

FIG. 1 is a circuit diagram of one embodiment of an inrush current limitation circuit in accordance with the present disclosure; and

FIG. 2 is a graph showing test results of the inrush current limitation circuit of FIG. 1.

### DETAILED DESCRIPTION

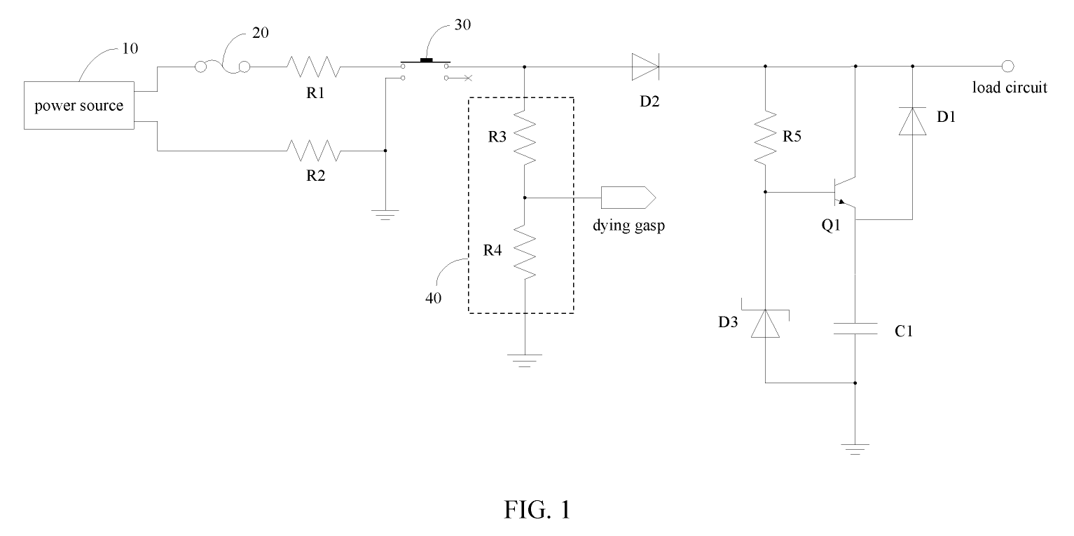

FIG. 1 is a circuit diagram of one embodiment of an inrush current limitation circuit in accordance with the present disclosure. The inrush current limitation circuit can be applied in an electronic device that supports dying gasp function and comprises a power source 10, a switch 30 and at least one load circuit, such as a modem. In this embodiment, the inrush current limitation circuit comprises a voltage dividing circuit 40, a transistor Q1, a first diode D1, a zener diode D3, a charging capacitor C1, and a second diode D2.

The power source 10 supplies a direct current voltage, for example 15 volts (V) direct current voltage. The voltage dividing circuit 40 comprises a first voltage dividing resistor R3 and a second voltage dividing resistor R4. The first voltage dividing resistor R3 and the second voltage resistor R4 are connected between the power source 10 and the ground in series in that order, to divide the direct current voltage so as to obtain a dying gasp voltage signal when the power source 10 stops providing the direct current voltage to the load circuit. Value of the dying gasp signal is adjustable by changing resistances of the first resistor R3 and/or the second resistor R4. In this embodiment, a central processing unit (CPU) determines the value of the dying gasp voltage signal.

The charging capacitor C1 is connected between an emitter of the transistor Q1 and ground, to store power when the switch 30 switches on. A base of the transistor Q1 is connected to a cathode of the second diode D2 though a biasing resistor R5, a collector of the transistor Q1 is connected to the switch 30, and the emitter of the transistor Q1 is connected to the charging capacitor C1. A cathode of the zener diode D3 is connected to the base of the transistor Q1, and an anode of the zener diode D3 is connected to ground. The zener diode D3 clamps a voltage between the base and the emitter of the transistor Q1 at a fixed value so as to avoid inrush current flowing through the charging capacitor C1 when the switch is switched on. An anode of the first diode D1 is connected to the emitter of the transistor Q1, and a cathode of the first diode D1 is connected to the cathode of the second diode D2.

Advantageously, the second diode D2 is connected between the switch 30 and the cathode of the first diode D1, wherein a cathode of the second diode D2 is connected to the cathode of the first diode D1. Thus, when the charging capacitor C1 discharges to the load circuit, the second diode D2 can prevent the discharge current flowing to the switch 30.

Preferably, the electronic device further comprises a fuse 20, a first filtering resistor R1, a second filtering resistor R2, and a biasing resistor R5.

The fuse 20 is connected between the power source 10 and the first filtering resistor R1. The fuse 20 protects the load circuit of the electronic device. The second filtering resistor R2 is connected between the power source 10 and ground. The fuse 20 and the first filtering resistor R1 are connected between the power source 10 and the switch 30 in series. The first filtering resistor R1 and the second filtering resistor R2 filter electromagnetic wave of the power source 10 to avoid electromagnetic interferences (EMI).

An input end of the switch 30 is connected to the second end of the first filtering resistor R1 and the second end of the second filtering resistor R2, and an output end of the switch 30 is connected to the anode of the second diode D2. When the switch 30 switches on, the power voltage signal from the power source 10 is transmitted to the load circuit and the inrush current limitation circuit.

A first end of the biasing resistor R5 is connected to the base of the transistor Q1, and a second end of the biasing resistor R5 is connected to the collector of the transistor Q1 to reduce current flowing through the base of the transistor Q1. In this exemplary embodiment, the resistance of the biasing resistor R5 is 10K ohm. According to base principles of the transistor Q1, a current flowing through the base of the transistor Q1 is I_{B}, a current flowing through the collector of the transistor Q1 is I_{C}, and a current flowing through the emitter of the transistor Q1 is I_{E}, thus I_{C}=βI_{B}, I_{E}=I_{C}+I_{B}=(1+β)I_{B}. The current value of I_{B} is low, so the current value of I_{E} is low. In this embodiment, when the direct current voltage signal input, the zener diode D3 clamps a fixed voltage level so that a voltage distributed upon the biasing resistor R5 is rather low and subsequently current flowing through the biasing resistor R5 is low. The current flowing through the base of the transistor Q1 is equal to a current I_{R5} flowing through the biasing resistor R5, so the current I_{C} flowing through the collector of the transistor Q1 is equal to βI_{B}, that is βI_{R5} is also low. A current flowing through the charging capacitor C1 at power-on instant is I_{C}, so there is no high current at the power-on moment. The anode of the first diode D1 is connected to the emitter of the transistor Q1, and the cathode of the first diode D1 is connected to collector of the transistor Q1.

The input end of the power source 10, the zener diode D3, and the transistor Q1 cooperatively form a common-emitter amplifier. When there is an inrush current, the zener diode D3 holds the base voltage of the transistor Q1 as a fixed value, such as the clamping voltage of the zener diode D3, and the second diode D2 prevents returning current, so that the current flowing through the collector of the transistor Q1 is reduced. The first diode D1 prevents returning current from a load circuit so that the current flowing through the charging capacitor C1 is reduced at the power-on instant.

The load circuit can normally work for a certain time period when the power source 10 stops providing the direct current signal, because the charging capacitor C1 discharges to maintain the load circuit working for 48 ms, in one example. The load circuit sends a power down message out to an external device in the certain time period.

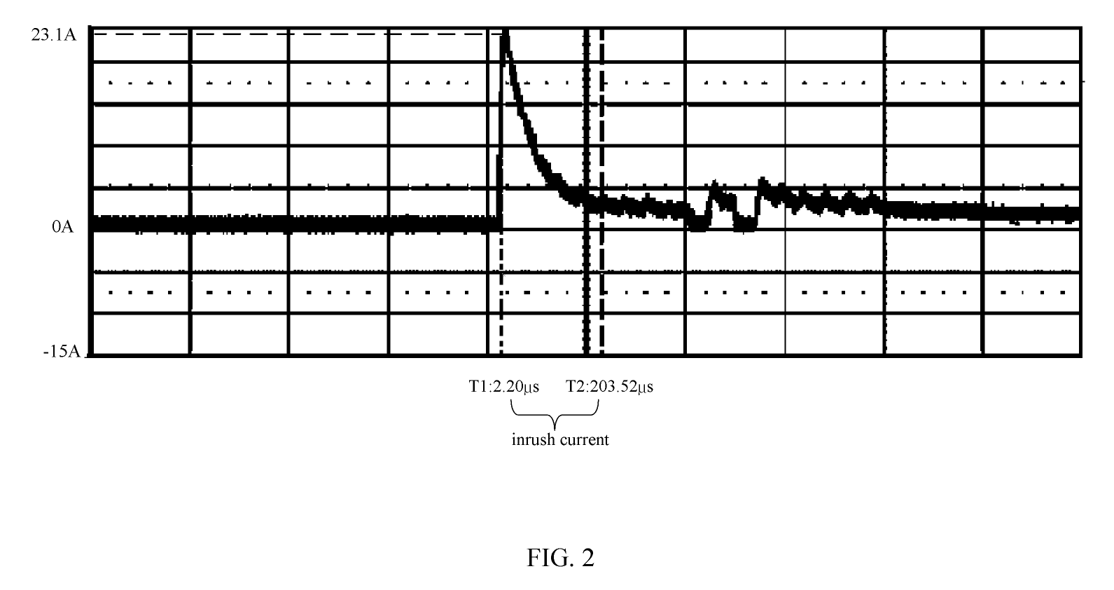

FIG. 2 is a graph showing test results of the inrush current limitation circuit of FIG. 1. At time T1, an inrush current occurs. A value of the inrush current is equal to 23.1 A via the inrush current limitation circuit, which is 11.8 A smaller than an inrush current 34.9 A of a conventional inrush current. At time T2, the current flowing through the circuit comes back to a normal current. In this embodiment, the time difference between the time T1 and the time T2 is about 203.52 μs−2.20 μs=201.32 μs, which is 153 μs smaller than an inrush current continuance time 354.4 μs of the conventional inrush current limitation circuit. Thus, the inrush current limitation circuit reduces the inrush current and the inrush current continuance time.

Although the features and elements of the present disclosure are described in various inventive embodiment in particular combinations, each feature or element can be configured alone or in various within the principles of the present disclosure to the full extent indicated by the broad general meaning of the terms in which the appended claims are expressed.

What is claimed is:

1. An inrush current limitation circuit configured between a switch connected to a power source and at least one load circuit of an electronic device for limiting inrush currents generated when the switch is switched on to power-on the electronic device, the power 5 source providing a direct current signal to power the at least one load circuit, the inrush current limitation circuit comprising:
a voltage dividing circuit connected between the switch and the ground, to divide the direct current signal so as to obtain a trigger voltage signal;
a transistor with a base connected to the switch via a biasing resistor and a collector 10 connected to the switch;
a charging capacitor connected between an emitter of the transistor and ground;
a zener diode with a cathode connected to the base of the transistor and an anode connected to ground, to fix a voltage between the base and the emitter of the transistor to avoid inrush current flowing through the charging capacitor when the switch is switched on; and
a first diode with an anode connected to the emitter of the transistor and a cathode connected to the at least one load circuit.

2. The inrush current limitation circuit as claimed in claim 1, wherein the biasing resistor reduces the direct current signal flowing through the base of the transistor.

3. The inrush current limitation circuit as claimed in claim 1, further comprising a second diode with an anode connected to the switch and a cathode connected to the cathode of the first diode.

4. An electronic device connected between a power source and a load circuit, the electronic device comprising:
a switch; and
an inrush current limitation circuit, comprising:
a voltage dividing circuit connected between the switch and the ground, to divide the direct current signal so as to obtain a trigger voltage signal;
a transistor with a base connected to the switch via a biasing resistor and a collector connected to the switch;
a charging capacitor connected between an emitter of the transistor and ground;
a zener diode with a cathode connected to the base of the transistor and an anode connected to ground, to fix a voltage between the base and the emitter of the transistor to avoid inrush current flowing through the charging capacitor when the switch is switched on;
a first diode with an anode connected to the emitter of the transistor and a cathode connected to the at least one load circuit; and
a second diode with an anode connected to the switch and a cathode connected to the cathode of the first diode.

5. The electronic device as claimed in claim 6, further comprising a fuse connected between the power source and the switch, to protect the inrush current limitation circuit.

6. The electronic device as claimed in claim 7, further comprising:
a first filtering resistor connected between the fuse and the switch; and
a second filtering resistor connected between the power source and the ground;
wherein the first filtering resistor and the second filtering resistor filter electromagnetic wave to avoid electromagnetic interferences.

7. The electronic device as claimed in claim 6, wherein the biasing resistor reduces the direct current signal flowing through the base of the transistor.
